(19) United States
(12) Patent Application Publication
(10) Pub. No.: US 2017/0323471 A1
(43) Pub. Date: Nov. 9, 2017

(54) 3D rendering method and 3D graphics processing device

(71) Applicants: National Taiwan University, Taipei City (TW); MEDIATEK INC., Hsin-Chu (TW)

(72) Inventors: Shao-Yi Chien, Taipei City (TW); Yen-Yu Chen, Tainan City (TW)

(21) Appl. No.: 15/588,725

(22) Filed: May 8, 2017

Related U.S. Application Data
(60) Provisional application No. 62/332,482, filed on May 6, 2016.

(51) Int. Cl. G06T 15/04; G06T 15/06; G06T 11/00; G06T 15/50; G06T 15/60; G06T 19/00

(52) U.S. Cl. CPC G06T 15/04; G06T 15/60; G06T 19/006; G06T 11/001; G06T 15/50; G06T 15/06; G06T 2215/16

(57) ABSTRACT

The present invention provides a method of 3D rendering processing, which includes obtaining a scene with a plurality of geometries and performing a first voxelization process according to the scene to obtain a first voxel scene; and performing a second voxelization process according to the scene and the first voxel scene to obtain a second voxel scene; wherein the first voxel scene comprises a plurality of first voxels and the second voxel scene comprises a plurality of second voxels

### CROSS REFERENCE TO RELATED APPLICATIONS

This application claims the benefit of U.S. Provisional Application No. 62/332,482 filed on 2016 May 6, the contents of which are incorporated herein in their entirety.

### BACKGROUND OF THE INVENTION

### 1. Field of the Invention

The present invention relates to a 3D rendering method and a 3D graphics processing device, and more specifically, to a 3D rendering method and a 3D graphics processing device for processing a scene according to a two-phase voxelization.

### 2. Description of the Prior Art

Because of the popularity about the virtual reality devices, the demand for video quality increases rapidly. People nowadays require images with high resolution and efficient memory usage. However, 3D rendering algorithms of the prior art cannot satisfy the requirements of high resolution and efficient memory usage at the same time. Therefore, it is necessary to improve the prior art.

### SUMMARY OF THE INVENTION

It is therefore a primary objective of the present invention to provide a 3D rendering method and a 3D graphics processing device, capable of processing images with high resolution and efficient memory usage, to improve over disadvantages of the prior art.

An embodiment of the present invention discloses a method of 3D rendering, comprising obtaining a scene with a plurality of geometries and performing a first voxelization process according to the scene to obtain a first voxel scene; and performing a second voxelization process according to the scene and the first voxel scene to obtain a second voxel scene; wherein the first voxel scene comprises a plurality of first voxels and the second voxel scene comprises a plurality of second voxels.

An embodiment of the present invention further discloses a 3D graphics processing device, comprising a processing unit; and a storage unit for storing a program code to instruct the processing unit to perform the following steps obtaining a scene with a plurality of geometries and performing a first voxelization process according to the scene to obtain a first voxel scene; and performing a second voxelization process according to the scene and the first voxel scene to obtain a second voxel scene; wherein the first voxel scene comprises a plurality of first voxels and the second voxel scene comprises a plurality of second voxels.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a two-phase voxelization according to an embodiment of the present invention.

FIG. 2 is a schematic diagram of a two-phase voxelization according to an embodiment of the present invention.

FIG. 3 is a schematic diagram of a two-phase voxelization according to an embodiment of the present invention.

FIG. 4 is a schematic diagram of a two-phase voxelization according to an embodiment of the present invention.

FIG. 5 is a schematic diagram of a two-phase voxelization according to an embodiment of the present invention.

FIG. 6 is a schematic diagram of a two-phase voxelization according to an embodiment of the present invention.

FIG. 7 is a schematic diagram of a two-phase voxelization according to an embodiment of the present invention.

FIG. 8 is a schematic diagram of a process according to an embodiment of the present invention.

FIG. 9 is a schematic diagram of a 3D graphics processing device according to an embodiment of the present invention.

### DETAILED DESCRIPTION

Global illumination is important for producing visual realism in various areas, such as in game development, architectural visualization, lighting design and film production. Recent advances in simulating global illumination are based on the rendering equation, which can be solved by utilizing the path integral formulation. Each path is composed of several rays, i.e., path segments, bounced within the scene according to the bidirectional reflectance distribution function (BRDF) of the surface. Therefore, ray tracing is the key to querying the first occluded surface point along the ray direction. The query process can be accelerated by adopting certain spatial acceleration structures (AS), such as bounding volume hierarchies (BVHs) and k-dimensional (k-d) trees. However, building and maintaining the AS is demanding, especially for fully dynamic scenes. It restricts the growth in the popularity of global illumination.

For indirect illumination, the first-bounce light path contains significant energy and is generally sufficient for most illumination effects. Many researchers exploit the first-bounce light path to quickly approximate the indirect illumination for interactive applications. To further accelerate the process, the scene geometry is simplified as points or voxels, which are directly illuminated for subsequent radiance queries. Instead of querying the radiance with rays or ray cones, the imperfect shadow map (ISM) degenerates the process of the intersection query into the visibility lookup on small deferred shadowmaps. This approach outperforms many algorithms in terms of speed, but at the expense of rendering quality. Although most interactive techniques can generate plausible visual quality, there are limitations in rendering detailed glossy reflections, especially in fully dynamic scenes.

Realizing that exact intersections are not always necessary for global illumination, the present invention provides a method of a quantized intersection framework to accelerate the querying process. The framework quantizes the intersections based on a voxelized representation of the scene. Each intersection is obtained by traversing the ray through a voxelized scene. It uses the centre of the first occluded voxel as an approximation. In test scenarios, the relation between the intersection accuracy and rendering quality was investigated. In the present invention, rendering with a voxel grid at the resolution of 1 K³ or above produces results very similar to those of ray tracing. In terms of memory consumption for the high-resolution voxels, the present invention discloses a two-phase binary voxelization technique to encode voxels as bits within two-dimensional (2D) textures on the graphics processing unit (GPU). As a result, the scene geometry can be better represented when compared with other interactive algorithms. In other words, the present invention can more accurately produce global illumination, such as detailed glossy reflections. Furthermore, several applications were applied for the present invention, including first-bounce indirect illumination, glossy refraction, path tracing, direct illumination and ambient occlusion, to demonstrate its feasibility for various illumination effects. In summary, the contributions of the present invention at least include:

A quantized intersection framework based on compact voxels;

A comprehensive evaluation of the intersection accuracy, rendering quality and memory usage of the framework;

Demonstrating the feasibility of the framework for various illumination effects.

To produce global illumination, the path-based formulation employs ray tracing to generate paths for estimating pixel intensity. An intersection query operation, that is, ray tracing, is critical to the rendering performance. Spatial acceleration data structures, such as BVHs and k-d trees, have been developed to speed up the query process. The exact intersection can then be obtained by performing the ray-primitive (or ray-triangle) intersection. Optix, a general-purpose ray tracing application program interface (API), provides users with an easier way to realize ray-tracing-based algorithms.

For light transport simulation, the first-bounce indirect light path significantly contributes to indirect illumination. Many researchers have exploited this feature and developed various interactive GPU based algorithms. Based on instant radiosity, reflective shadow maps (RSMs), for example, are used to store first bounce indirect light sources. They are maintained as deferred textures on the GPU for radiance lookups. In addition, some algorithms have been proposed that leverage the RSMs and achieve real-time performance. However, these methods typically suffer from incorrect lighting on account of the lack of visibility evaluation between the shading point and the RSMs.

Instead of querying the original geometry, certain approaches adopt simplified geometries as proxies for visibility or intersection evaluations. These approaches can be categorized into two types—points and voxels—and are discussed below.

Point-based approach: ISM-based techniques sparsely discretize the scene as point proxies and rasterize low-resolution shadow maps for occlusion queries. These techniques are used to approximate the visibility between the virtual point light (VPL) and the shading point. However, these approaches are often limited to low-frequency illumination (e.g. diffuse reflections) and have difficulty producing detailed illumination, such as glossy reflections. Point-based global illumination represents the scene with very dense point samples, which contain first-bounce energy and are managed as a point hierarchy or clusters. Similar to the ISM-based approach, the visibility is determined by utilizing micro z-buffers. The indirect contribution is then derived by integrating the directly illuminated micro-frame buffers.

Voxel-based approach: Another geometry proxy is the voxel, which is popular on account of its efficient implementation on GPUs. The voxel based approach proposed the light propagation volume (LPV), which can produce low-frequency indirect illumination by propagating the energy among voxels. A view-dependent variant with a nested-grid structure was then presented to provide high voxel resolution for the part of the scene close to the camera. Although LPV can render dynamic scenes in real time, it is limited to diffuse and low glossy reflections; moreover, it may cause light leaking due to insufficient voxel resolution. Although the voxel grid method was adopted to accelerate the visibility evaluation during ray tracing. Although the voxel-based global illumination (VGI) approach reaches real-time performance, it is limited to near-field indirect illumination and is merely aimed at diffuse materials. Voxel cone tracing (VCT) utilizes the voxel representation as both occlusion and radiance queries. Each ray cone accumulates and blends radiance within each voxel it visits. For memory efficiency, voxels are usually stored in the form of a sparse voxel octree (SVO). However, it still incurs too much memory usage at high resolutions. The sparse voxel directed acyclic graph (DAG) further reduces memory consumption by allowing nodes to share pointers to identical subtrees. Another way to relieve the burden of memory usage in VCT is through the use of a layered reflective shadow map (LRSM), which encodes lighting data in the layered RSM.

Instead of querying the exact intersection in ray tracing, the present invention proposes a simple and efficient approach to approximating it with a quantized estimation that can be efficiently derived. The present invention discretizes the scene using a uniform voxel grid at the resolution of N³. Each voxel is binarized based on the binary mapping function O(v)→{0, 1} to identify whether the voxel, v, is overlapped by the scene geometry. The voxelized scene can be regarded as the downsampled geometry; the binarized voxels can be considered the geometry proxies while querying the intersections. Consequently, the intersections can be obtained by casting rays to traverse the voxel grid. The centre of the first occluded voxel along the ray direction (i.e. O(v)=1) is adopted as the approximated intersection. As N increases, the approximation error is proportionally decreased to a value that is trivial in affecting the rendering result.

Nevertheless, it is not practical to directly increase the voxel resolution because the memory consumption grows cubically with respect to N. For example, representing the scene with a uniform voxel grid at the resolution of 2 K³ (one bit for each voxel) requires 1 GB, which is demanding for many rendering applications. Thus, the present invention utilizes a two-level structure generated by the proposed two-phase voxelization technique to relieve the burden of memory usage.

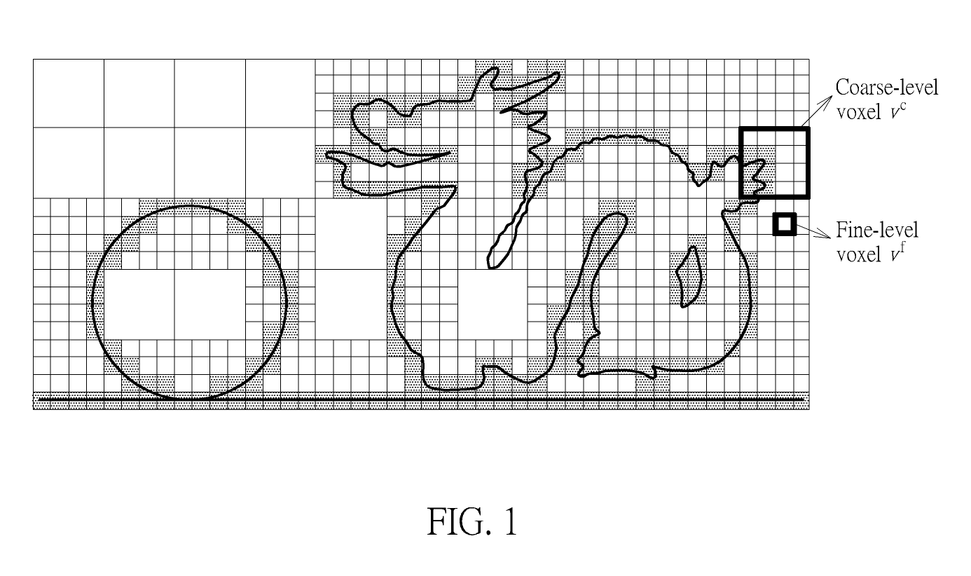

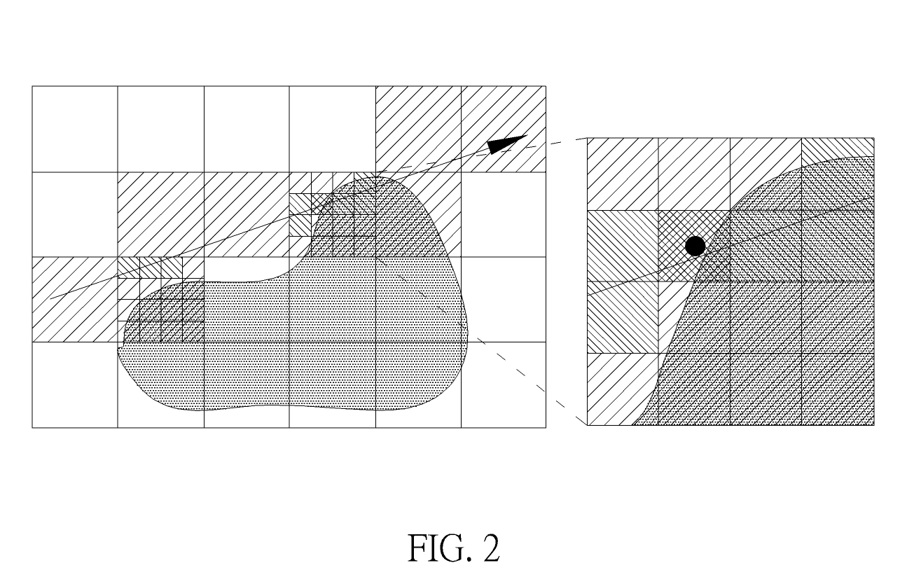

First, the scene is roughly partitioned to M³ coarse-level voxels v^{c}, where M<N. Then, each coarse-level voxel is further subdivided into K³ fine-level voxels, v^{f}, K=N/M, if O(v^{c}) equals 1 (FIG. 1). Superscripts c and f, respectively, indicate the coarse and fine-level properties. Through the two-phase voxelization, the present invention consumes no more than 200 MB for the voxelized scene at the voxel resolution of 2 K³ in most cases (Table 1). In terms of traversal, this query approach of the present invention is also a two-phase process as depicted in FIG. 2. The centre of the first occluded voxel along the ray is taken as the approximation for the intersection query.

TABLE 1

| | 128³(VGI) | 256³ | 512³ | 1K³ | 2K³ |
|---|---|---|---|---|---|
| Dragon Box | 13/0.33/−32% | 6.3/1.9/5% | 3.4/8.8/45% | 1.8/38.8/70% | 1.2/165.5/84% |
| Conference | 25.2/0.33/−32% | 18.7/0.7/65% | 11.2/3.1/81% | 7.0/14.8/88% | 5.3/58.8/94% |
| SPONZA | 23.1/0.33/−32% | 15.4/1.2/40% | 10.3/6.8/58% | 7.7/29.5/77% | 6.1/128.1/87% |

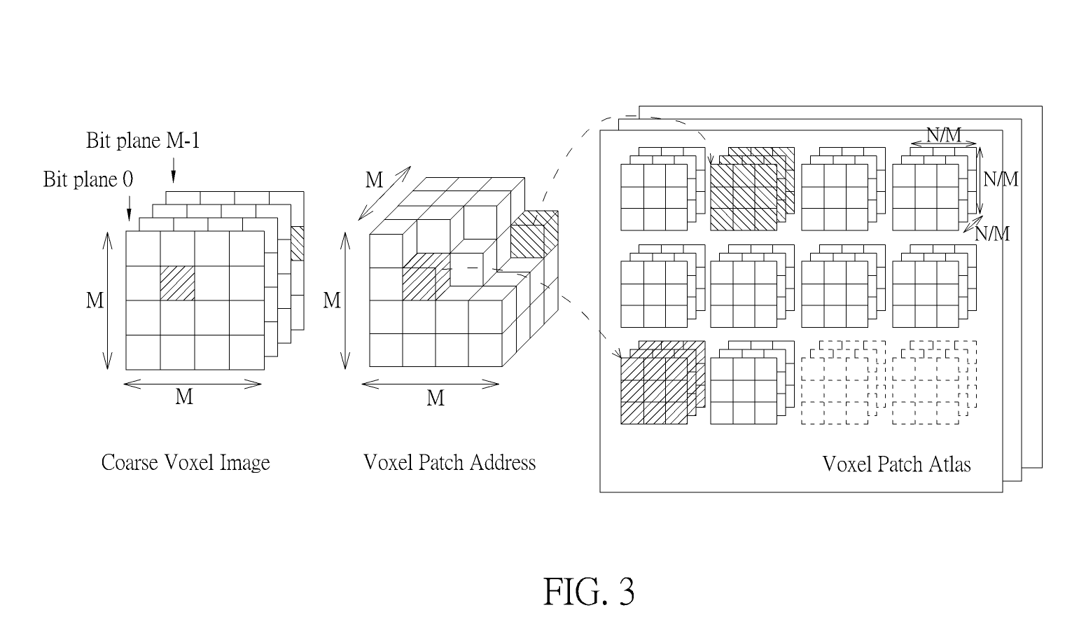

The GPU implementation of the proposed two-phase voxelization technique is now described. Because the occlusion data of the scene geometry is represented as binary voxels, the present invention encodes the data as bits in 2D textures. The coarsely discretized scene represented with M³ coarse-level voxels is encoded in one M×M 2D texture, which is regarded as the coarse voxel image (CVI). The fine-level voxels within the coarse-level voxel are stored as a 2D image patch. All patches are densely packed in large 2D textures—voxel patch atlases (VPAs)—and are bound in a 2D texture array if necessary. The address pointing to a voxel patch in the VPAs is stored in the first 31 bits of the texel in a separate 3D texture. The last bit of each texel is used to identify whether the address is valid. FIG. 3 illustrates an example of the proposed two-level structure with M=4 and N=12.

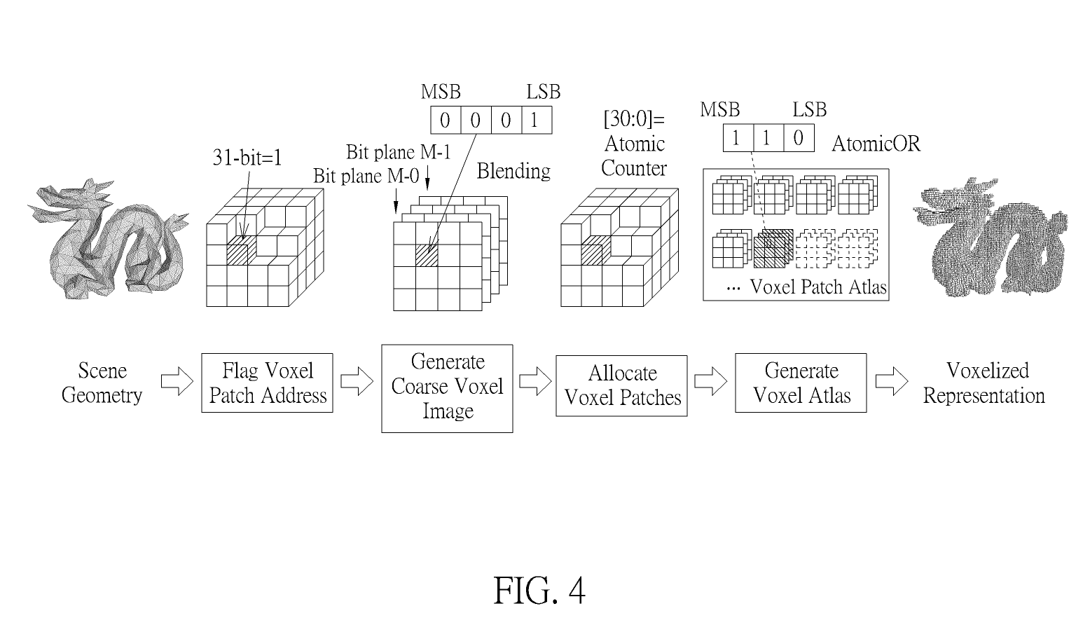

The two-phase voxelization technique is illustrated in FIG. 4. The scene is first voxelized at the voxel resolution of M³ using a GPU-based voxelization approach. Instead of generating an auxiliary buffer object for all voxel fragments, the present invention flags in the fragment shader the corresponding texel of the 3D texture according to their coordinates. For each flagged texel in the 3D texture, the present invention sets the bit corresponding to the same voxel encoded in the CVI to 1 by blending the pixel with the appropriate value. To densely pack the voxel patches within the VPAs, the present invention uses an atomic counter, which records the index for the next available space in the VPAs, to generate a unique address for each of them. Finally, another draw call is activated with the size of the render target set to N. Once the voxel fragments are generated through the rasterization stage, the addresses of the voxel patches to which they belong are retrieved from the 3D texture, and the corresponding texels in the VPAs are then updated. It should be noted that, during the generation of the VPAs, the texel in the VPAs might be simultaneously modified by several fragment threads. Thus, the present invention uses imageAtomicOr operations to avoid the race condition. Consequently, the size of the voxel patch is fixed to 32×32 in the current implementation owing to the limitation of the atomic operation.

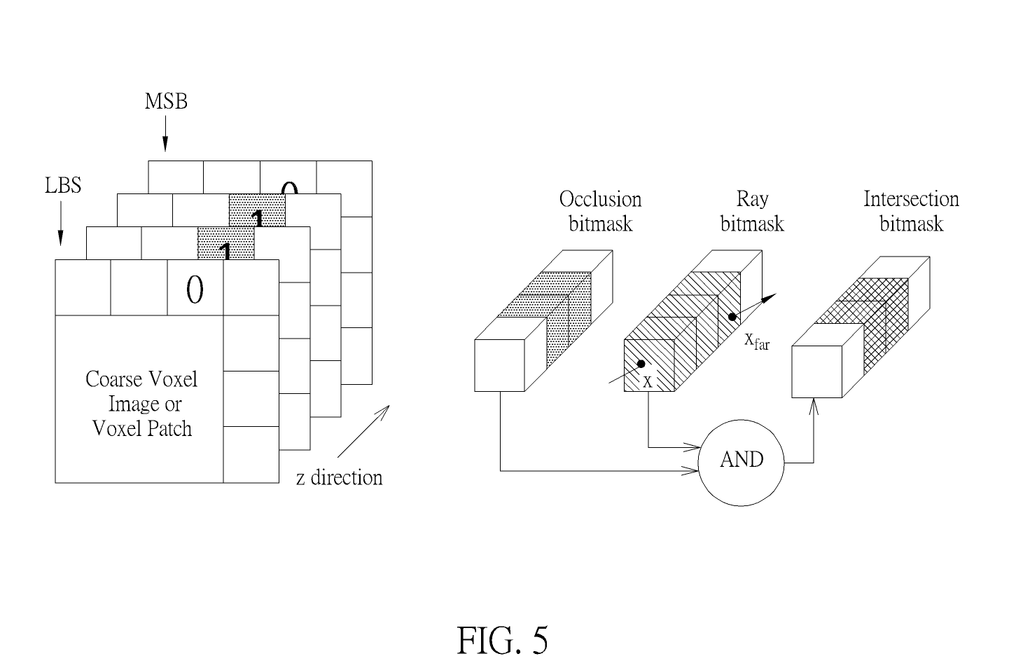

Two-phase binary ray marching is extended from the ray-voxel intersection test and is summarized in FIG. 5. First, the coarse-level voxel, v^{c}, in which the ray origin resides is obtained by projecting the ray origin into the coarse-level voxel grid. As shown in FIG. 5, the present invention then calculates the intersection, x^{c}_{far}, between the ray and the extended bounding box, B (v^{c}). B (v) is defined as a bounding box encompassing voxel v with its z-dimension extended to scene's extent. The intersection is used to form a coarse-level ray bitmask along the depth direction in the coarse-level voxel grid. A coarse-level occlusion bitmask is obtained by fetching the corresponding texel in the CVI. Then, a coarse-level intersection bitmask, m^{c}ᵢₙₜₑᵣₛ is generated by ANDing these two bitmasks. If there is no set bit in the intersection bitmask—that is, the value of the bitmask is zero—we proceed to the next coarse-level voxel by advancing the ray origin to x^{c}_{far}. Otherwise, a fine-level traversal is activated inside the first occluded coarse-level voxel, v^{C}₁, along the z-direction, with its l-th location counted from the least significant bit (LSB) in m^{c}ᵢₙₜₑᵣₛ.

The procedure of the fine-level traversal is similar to the coarse-level one, but it occurs on the voxel patch in the VPAs. Once an occluded fine-level voxel is found, the centre of the voxel is used as an approximation for the intersection. Otherwise, it returns to perform the coarse-level traversal with an updated coarse-level bitmask. To update the coarse-level bitmask, the present invention subtracts from it an integer value, 2^{l}. Then, the coarse-level traversal continues until the value of the coarse-level bitmask decreases to zero. To enhance the traversal performance, the present invention builds mipmaps for both the CVI and VPAs. The main difference between the method of the present invention and VGI is that the present invention provides intersections more accurately, which is the key to rendering detailed glossy reflections.

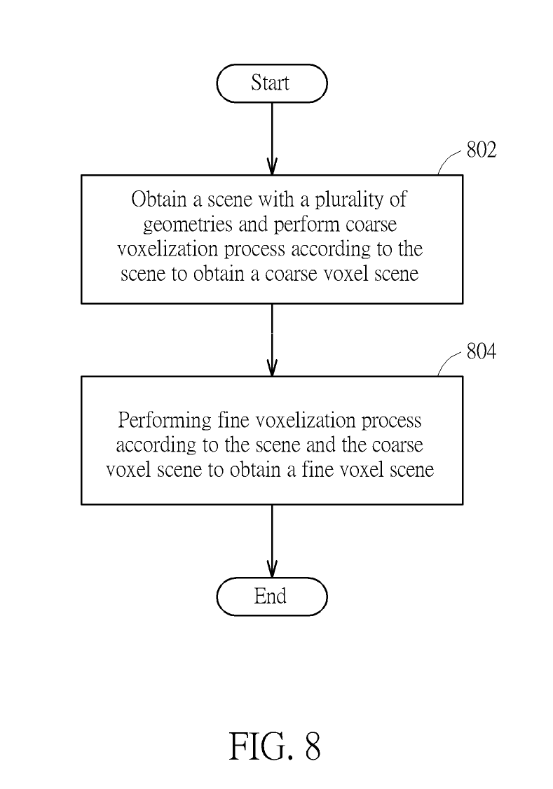

The operations of the present invention may be summarized into a process 80, as shown in FIG. 8. The process 80 comprises the following steps:

Step 800: Start.

Step 802: Obtain a scene with a plurality of geometries and perform a coarse voxelization process according to the scene to obtain a coarse voxel scene.

804: Perform a fine voxelization process according to the scene and the coarse voxel scene to obtain a fine voxel scene.

Step 806: End.

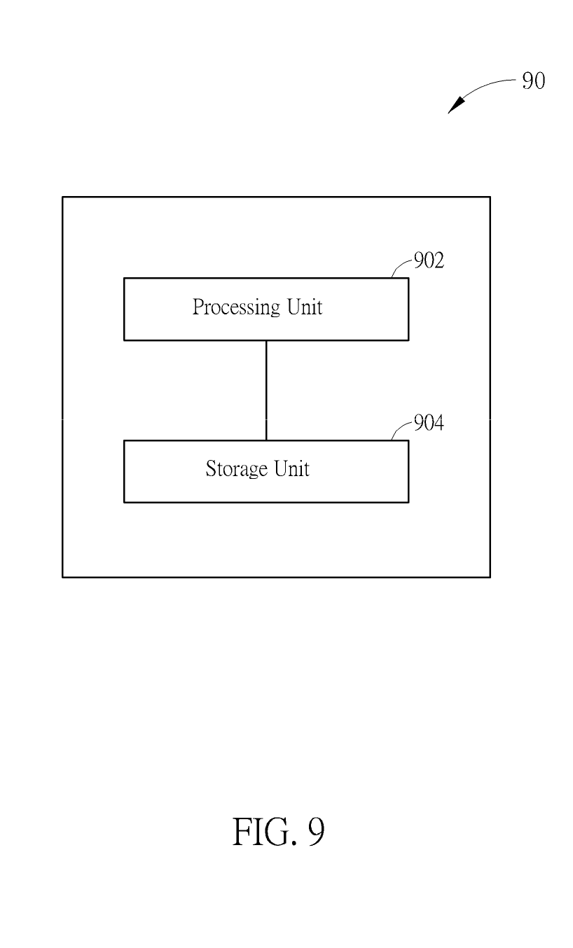

FIG. 9 further illustrates a 3D graphics processing device 90. The 3D graphics processing device 90 comprises a processing unit 900 and a storage unit 902. The storage unit 902 is configured to instruct the processing unit 900 to execute the steps of the process 80, so as to realize compact voxels.

Furthermore, the present invention evaluates the intersection accuracy of the proposed framework and shows the effect of the quantization on the rendering quality at various voxel resolutions. The memory usage of the two-level structure of the present invention is also analyzed.

To quantify the accuracy of the quantized intersections, the present invention measures the intersection error

$$ε ( pi ) = \frac{1}{S} \sqrt{\frac{1}{{N}_{r}} {\sum }_{j = 1}^{{N}_{r}} {‖ {x}_{i , j} - {\hat{x}}_{i , j} ‖}^{2}} ∈ [ 0 , 1 ]$$

by calculating the average disparity between the exact and quantized intersections of Nᵣ rays, which are randomly sampled over the hemisphere on shading point pᵢ (i.e. deferred pixel i), where S is the normalization term with respect to the scene size. In addition, \hat{x} and x, respectively, represent the exact and quantized intersections.

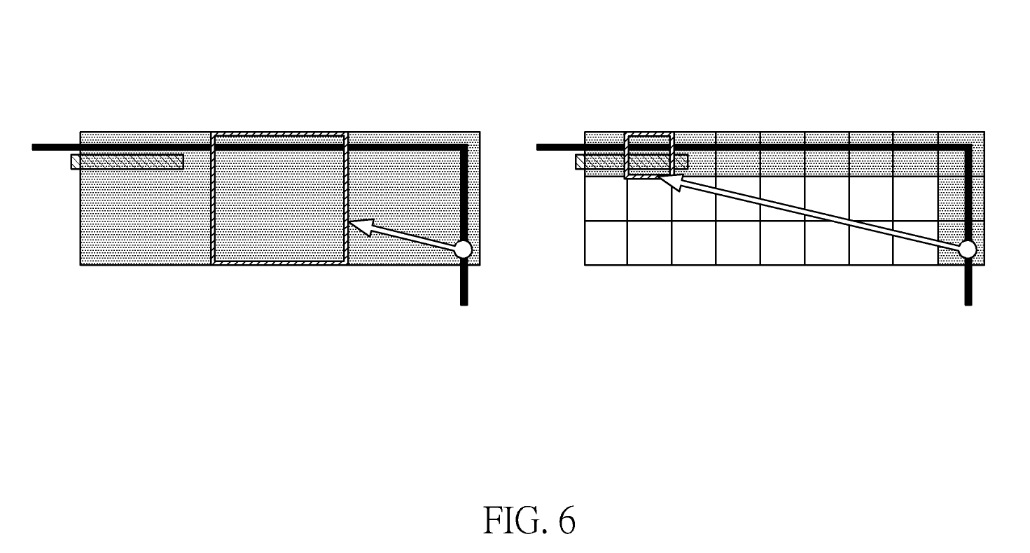

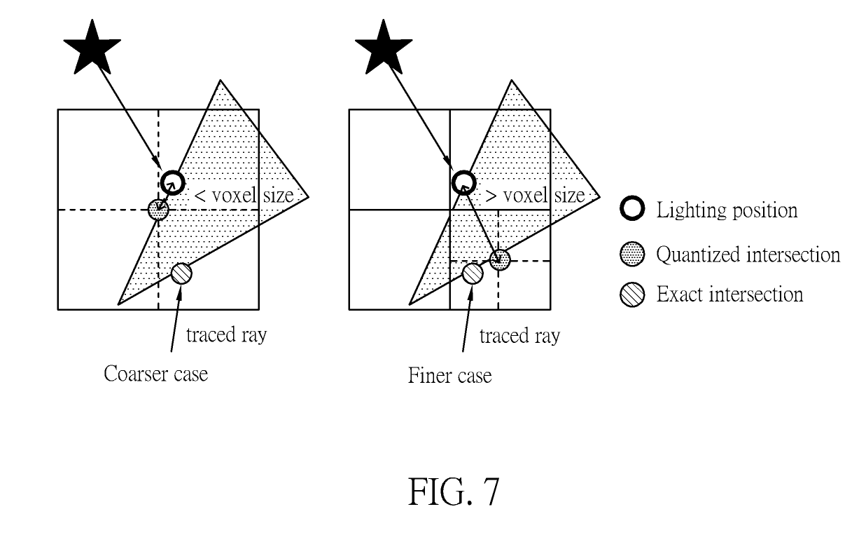

In terms of rendering quality, the present invention investigates the first-bounce indirect illumination at various voxel resolutions. To determine the effect of the quantized intersections on detailed glossy reflections, the floors in DRAGON BOX and SPONZA are set as highly glossy reflective. For each shading point, the present invention samples and casts 1024 final gather rays according to the surface BRDF to the scene. Querying the intersection in the scene with under-sampled geometries usually suffers from over- or under-occlusion around the intersection, such as in the cases, respectively, depicted in FIGS. 6 and 7. Taking the voxel grid with a resolution of 128³ as an example, the light leaking (i.e. under-occlusion) occurs at the intersection between the sphere and the wall in DRAGON BOX.

The indirect shadow near the chair leg disappears in CONFERENCE. This artefact occurs in many voxel-based techniques and worsens if the geometry is excessively approximated. In the case of SPONZA, the glossy reflections from the blue curtain and vase are seriously corrupted when the voxel resolution is set to 512³ or below. These artefacts can be effectively reduced if high-resolution voxels are used. Therefore, it may conclude that the voxel grid with a resolution of 1 K³ or above would be suitable for rendering detailed indirect illumination.

Moreover, the present invention demonstrates the framework of the present invention on several applications, including first-bounce indirect illumination, glossy refraction, path tracing, direct illumination and ambient occlusion. All the images were rendered at a resolution of 512×512 on a PC with an NVIDIA GeForce GTX 770 graphics card. Unless otherwise mentioned, the present invention uses OpenGL 4.2 and the GL shading language for all implementations.

First-bounce indirect illumination: The G-buffers and RSMs are individually rendered from eye and light perspectives. The scene geometry is voxelized and binarized at a resolution of 1 K³ using the proposed two-phase voxelization technique. Then, for each shading point, 16 final gather rays are cast according to the surface BRDF to gather the first-bounce radiance. Once an occluded voxel is discovered along the ray, the present invention examines the distance between the centre of the occluded voxel and the position stored in the projected pixel in the RSMs. If the distance is smaller than δ=max(δᵥ, δᵣ), where δᵥ and δᵣ, respectively, denote the voxel size and reconstructed pixel size of the RSM at that voxel centre, the radiance stored in the corresponding RSM pixel is retrieved for accumulation. Otherwise, the present invention discards the contribution of the ray. The bilateral filtering is subsequently applied on the rendered image to reduce the noise. In addition to Gaussian-based geometric weights, the present invention introduces an auxiliary similarity term based on the shininess to prevent over smoothing on edges between diffuse and glossy reflections.

The present invention implements the VCT by injecting the first-bounce radiance into a 256³ voxel grid, which was further mipmapped with anisotropic filtering. Compared with VGI, the method of the present invention produces better results on detailed glossy reflections, such as the reflections from horse legs and the blue curtain on the floor in HORSE SPONZA. Under-occlusion occurs in VGI, causing the image to be brighter than in the reference, such as in places at the back wall and floor in BUDDHA BOX. The situation deteriorates when using VCT, such as in the blue color on the Buddha's head in BUDDHA BOX and the reflection from the banner on the floor in HORSE SPONZA. This is because the first-bounce radiance is always pre-filtered and blended from voxels through which the ray cone passes. With the proposed two-level structure, the present invention voxelizes the scene at a higher voxel resolution and could thus obtain more accurate intersections.

Table 3 shows a performance comparison between the method of the present invention, VGI, VCT and Optix for HORSE SPONZA. The method of the present invention ran at an interactive speed, similar to the others, and produced detailed glossy reflections for fully dynamic scenes. The full sequence is attached in the supporting information Video S1. The computation time of each individual stage of the proposed voxelization technique is listed in Table 4.

TABLE 3

| | Present | | | |
|---|---|---|---|---|
| | Invention | VGI | VCT | Optix |
| Voxel-grid/AS | 16 ms | 5 ms | 185 ms | 150 ms |
| Rendering | 76 ms | 12 ms | 4 ms | 284 ms |

TABLE 4

| | Buddha Box | Horse Sponza |
|---|---|---|
| Flag 3D Texture | 2.3 ms | 6.6 ms |
| Generate CVI | 0.06 ms | 0.16 ms |
| Allocate Voxel Patch | 0.09 ms | 0.12 ms |
| Generate VPA | 3.7 ms | 8.4 ms |
| Mipmapping | 0.45 ms | 0.72 ms |

Glossy refraction: The present invention could be extended to produce glossy refractions based on certain image-space approaches. First, the present invention renders the relative refraction index and normal of the back-facing surface to the texture, which is denoted as the BackFace texture. To render a shading point located at the refractive surface, several refractive rays were generated according to the refractive property. An approximated intersection could be obtained by traversing the refractive ray through the voxelized scene. Then, the present invention projects the intersection to the BackFace texture to reference the relative refraction index and corresponding normal. The outgoing refractive ray could be generated at the backfacing surface. Again, the outgoing refractive ray could query an approximated intersection based on the framework of the present invention, and the radiance could be retrieved from the RSMs. The rendered image was applied with the bilateral filter to remove the noise.

Path tracing: The framework of the present invention is applied to realize path tracing. Storing the geometry and radiance in voxels consumes a large amount of memory at the high voxel resolution. Instead, the present invention uses a lightweight approach to grow paths. To generate the path segment, the present invention employs one draw call to voxelize the surface attributes of the scene and only retained the ones required for the current iteration. The path throughput and its contribution were maintained in different textures. In addition, the method of the present invention supports interactive manipulations.

Direct illumination: Direct illumination produces accurate shadows by evaluating the visibility tests between the shading points and the light samples on the light source. Several approximations have been proposed to accelerate the process. Similar to the process, the present invention manipulates the voxel as the geometry proxy for the evaluation of direct occlusion. By adopting the appropriate voxel resolution, the result of the present invention is comparable to the reference and has a small normalized root mean squared error (NRMSE).

Ambient occlusion: Ambient occlusion enhances visual realism by imposing soft shadows on diffuse objects. It is practically computed as

$$AO ( p , ω ) = \frac{1}{π} {\int }_{Ω} ρ ( D ( p , ω ) ) ( ω \cdot n ) d ω ,$$

where p and n are the querying surface point and its normal, respectively, D(p,ω) measures the distance from p to the first occlusion in the direction of ω, and ρ is the falloff function that maps the distance to an occlusion value between 0 and 1. The framework of the present invention uses voxels for the occlusion detection to approximate D(p, ω).

Through the use of the compact encoding scheme and two-level structure, the occlusion data can be stored with moderate memory usage. However, it sometimes becomes less memory efficient when only a few bits are set in most voxel patches. This situation occurs in a scene where the geometries are mainly composed of large triangles. For example, there are only 3.1% set bits in VPAs. To efficiently address this scene type, an SVO or a sparse voxel DAG may be a better option. Although sparse voxel DAG cannot be built at interactive speeds, in terms of memory usage, it is more efficient than the method of the present invention. For example, for SPONZA voxelized at a resolution of 2 K³, spare voxel DAG only consumes 4 MB for storage, as listed in Table 2, and the method of the present invention requires approximately 128 MB.

TABLE 2

| | Present | | | |
|---|---|---|---|---|
| | invention | VGI | SVO | Uniform |
| Dragon Box | 38.8 | 0.33/21.3 | 47.0 | 128 |
| Conference | 14.8 | 0.33/21.3 | 18.5 | 128 |
| Sponza | 29.5 | 0.33/21.3 | 53.7 | 128 |

While the quantized intersection framework of the present invention can provide plausible indirect illumination with modest memory usage, it has several limitations. First, it suffers from under-occlusion when the ratio of the voxel size to the geometry becomes too large. This artefact becomes more obvious when zooming-in on the geometry detail of the small object inside a large scene. Second, it is difficult to produce mirror-like reflections on account of the discretization of the scene. This limitation also affects most interactive algorithms, which adopt another geometry proxy for visibility or radiance queries. Moreover, the temporal flickering is likely to occur on highly glossy surfaces (e.g. at the back of the Buddha in the supporting information Video S1). This is because complex geometric details on shading points cause high variances on gathered energy when a limited number of rays is used.

In summary, the present invention discloses a quantized intersection framework based on compact voxels, with which the memory usage of the occlusion data for high-resolution voxels can be effectively reduced. A comprehensive evaluation reveals that the framework of the present invention can produce high-fidelity illumination at the voxel resolution of 1 K³ or above with moderate memory usage. In addition, a two-phase voxelization technique on the GPU was proposed. The method enables the rendering of fully dynamic scenes at interactive speeds. Finally, the framework was applied to several applications to demonstrate its feasibility for various illumination effects. In future work, the present invention may apply the framework to many light rendering systems that typically use standard shadow mapping or ray tracing to solve numerous visibility tests between VPLs and shading points. The quantized intersection framework of the present invention is expected to be a good alternative to balancing the rendering performance and quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of 3D rendering processing, comprising:
obtaining a scene with a plurality of geometries and performing a first voxelization process according to the scene to obtain a first voxel scene; and
performing a second voxelization process according to the scene and the first voxel scene to obtain a second voxel scene;
wherein the first voxel scene comprises a plurality of first voxels and the second voxel scene comprises a plurality of second voxels.

2. The method of claim 1, wherein the first voxelization process uniformly separates the scene into first voxels and flags the first voxels correspond to the geometries in the scene to generate the first voxel scene.

3. The method of claim 1, wherein the second voxelization process uniformly separates the first voxel scene into second voxels and flags the second voxels correspond to the geometries in the scene to generate the second voxel scene.

4. The method of claim 1, further comprising:
generating a first file, to store the first voxel scene;
generating a plurality of second files, to store the second voxel scene;
generating a third file, to store the plurality of second files; and
generating a fourth file, to store a plurality of addresses pointing to the plurality of second files in the third file;
wherein the format of the first file, the second file and the third file is in a 2D texture.

5. A 3D graphics processing device, comprising:
a processing unit; and
a storage unit for storing a program code to instruct the processing unit to perform the following steps:
obtaining a scene with a plurality of geometries and performing a first voxelization process according to the scene to obtain a first voxel scene; and
performing a second voxelization process according to the scene and the first voxel scene to obtain a second voxel scene;
wherein the first voxel scene comprises a plurality of first voxels and the second voxel scene comprises a plurality of second voxels.

6. The 3D graphics processing device of claim 5, wherein the storage unit further instructs the processing unit to perform the following steps, for performing the first voxelization process:
separating the scene uniformly into first voxels and flagging the first voxels correspond to the geometries in the scene to generate the first voxel scene.

7. The 3D graphics processing device of claim 5, wherein the storage unit further instructs the processing unit to perform the following steps, for performing the second voxelization process:
separating the first voxel scene uniformly into second voxels and flagging the second voxels correspond to the geometries in the scene to generate the second voxel scene to perform the second voxelization process.

8. The 3D graphics processing device of claim 5, wherein the storage unit further instructs the processing unit to perform the following steps:
generating a first file, to store the first voxel scene;
generating a plurality of second files, to store the second voxel scene;
generating a third file, to store the plurality of second files; and
generating a fourth file, to store a plurality of addresses pointing to the plurality of second files in the third file;
wherein the format of the first file, the second file and the third file is in a 2D texture.
